(19) United States
(12) Patent Application Publication
(10) Pub. No.: US 2021/0245351 A1
(43) Pub. Date: Aug. 12, 2021

(54) Drill Holder

(71) Applicant: Castle & Pryor Ltd., Hampshire (GB)

(72) Inventor: Graham Pryor, Surrey (GB)

(21) Appl. No.: 16/973,582

(22) PCT Filed: Jun. 12, 2019
(86) PCT No.: PCT/EP2019/065397

§ 371 Date: Dec. 9, 2020

(30) Foreign Application Priority Data
Jun. 13, 2018 (GB) 1809664.4

(51) Int. Cl. B25D 17/28; B25H 1/00

(52) U.S. Cl. CPC B25D 17/28; B25H 1/0064; B25H 1/0028

(57) ABSTRACT

A drill holder includes a base, an elongate support member extending substantially perpendicularly from the base, and an arm mounted to the support member. The arm extends substantially perpendicularly from the support member and is free to slide along at least a portion of the support member. The arm includes holding means for holding a drill and a weight.

### TECHNICAL FIELD

The present disclosure relates to a drill holder for holding drills including, but not limited to, rotary percussion drills for drilling into stone, concrete, brick or mortar.

### BACKGROUND

Drills, such as rotary percussion drills or rotary hammer drills, are used for drilling into stone, concrete, brick or mortar. Such drills provide a hammering action to move the drill bit in and out while the drill bit is spinning.

Use of such drills exposes workers to hand-arm vibration, which may lead to, for example, hand-arm vibration syndrome and carpal tunnel syndrome.

### BRIEF SUMMARY

In a first aspect, the present invention provides a drill holder comprising a base, an elongate support member extending substantially perpendicularly from the base, and an arm mounted to the support member. The arm extends substantially perpendicularly from the support member. The arm is free to slide along at least a portion of the support member. The arm comprises holding means for holding a drill and a weight.

The arm may comprise a first end and a second end opposite to the first end. The arm may be slidably attached to the support member at the first end. The holding means may be located at the second end. The weight may be located between the first end and the second end.

The support member may comprise a plurality of first through holes spaced apart along its length. The arm may comprise a second through hole configured to align with each of the first through holes when the arm is located at a different respective position along the length of the support member. The drill holder may further comprise a locking pin for inserting through the second through hole and a first through hole aligned therewith.

The arm may further comprise a handle.

The support member may have a length of less than or equal to 2 m.

The weight may have a weight of between 0.5 kg and 5.0 kg, e.g. between 0.5 kg and 2.5 kg, e.g. between 1.0 kg and 2.0 kg, e.g. between 1.0 kg and 1.5 kg. The weight may have a variable mass or weight.

The drill holder may further comprise a vacuum system coupled to the base.

The drill holder may further comprise attachment means for fixedly attaching the base to a surface to be drilled.

The base may comprise a plurality of lockable wheels. The base may comprise a guide hole for receiving and guiding a drill bit of a drill held by the holding means.

The arm may further comprise vibration damping means.

In a further aspect, the present invention provides a system comprising a plurality of drill holders, each of the drill holders being in accordance with any of the above aspects, wherein the bases of the drill holders are integrally formed.

In a further aspect, the present invention provides a drilling system comprising a drill holder in accordance with any of the above aspects, a drill fixedly held by the holding means of the drill holder.

The drill may be selected from a group of drills consisting of a rotary percussion drill, a hammer drill, a rotary hammer drill, a percussive breaker, an electric drill, a pneumatic drill, and a hydraulic drill.

The drilling system may further comprise a controller for activating and deactivating the drill, wherein the controller is remote from the drill holder and the drill.

A weight of the drill may be less than or equal to 50 kg, e.g. between 5 kg and 10 kg.

In a further aspect, the present invention provides a drilling method comprising: providing a drill holder, the drill holder being in accordance with any of the above aspects; fixedly coupling the base to a surface of material to be drilled; holding, by the holding means, a drill; activating the drill; and applying, by the weight under gravity, a downwards force to the drill, thereby to force the drill against the surface.

Prior to the holding of the drill by the holding means, the arm may be prevented from moving with respect to the support member by means of a locking pin positioned through a first hole through the arm and a second hole through the support member, the first and second holes being aligned. The method may further comprise, following activation of the drill, removing the locking pin from the first and second holes.

Activating the drill may comprise remotely activating the drill by a controller remote from the drill holder and the drill.

The material may comprise at least one of stone, concrete, brick, or mortar.

### BRIEF DESCRIPTION OF THE DRAWINGS

FIG. 1 is a schematic illustration (not to scale) of a perspective view of a drill holder.

FIG. 2 is a schematic illustration (not to scale) of a side view of the drill holder.

FIG. 3 is a schematic illustration (not to scale) of a front view of the drill holder.

FIG. 4 is a process flow chart showing certain steps of a drilling process.

### DETAILED DESCRIPTION

It will be appreciated that relative terms such as horizontal and vertical, top and bottom, above and below, front and back, and so on, are used below merely for ease of reference to the Figures, and these terms are not limiting as such, and any two differing directions or positions and so on may be implemented rather than truly horizontal and vertical, top and bottom, and so on.

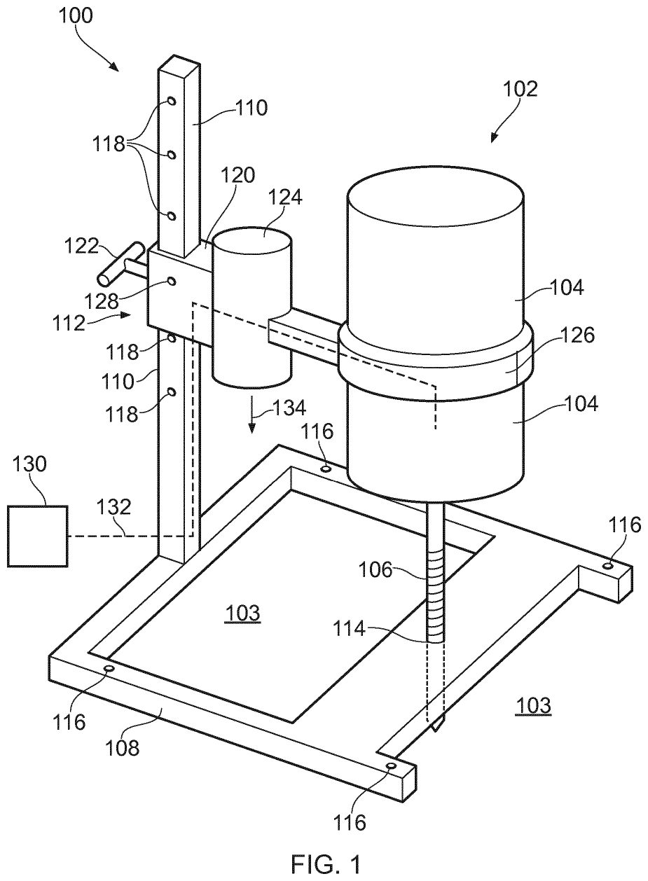

FIG. 1 is a schematic illustration (not to scale) of a perspective view of an embodiment of a drill holder 100.

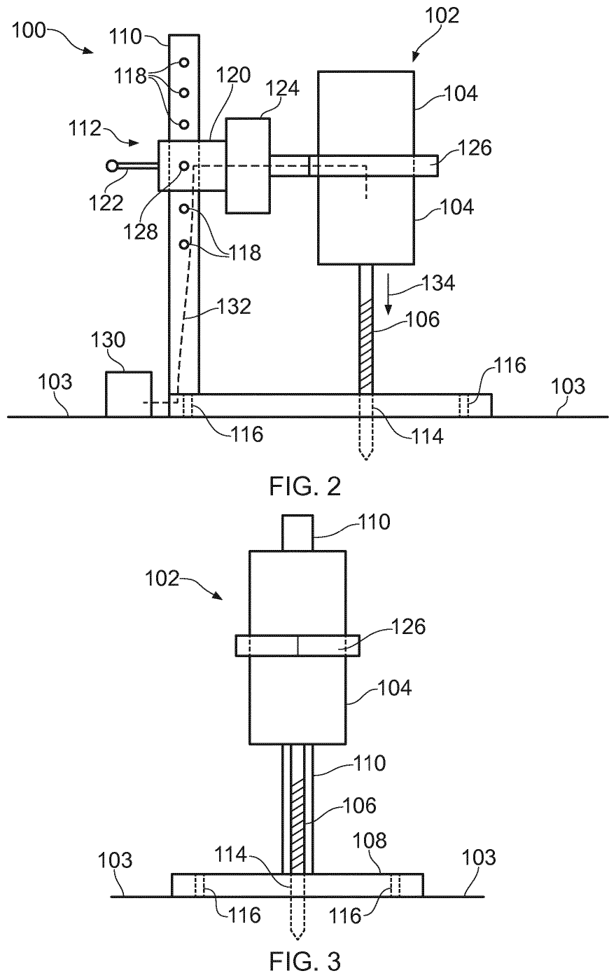

FIG. 2 is a schematic illustration (not to scale) of a side view of the drill holder 100.

FIG. 3 is a schematic illustration (not to scale) of a front view of the drill holder 100.

The drill holder 100 is shown in FIGS. 1 to 3 in use, i.e., holding a drill 102 and forcing the drill 102 against a surface 103 being drilled. The surface may be, for example, the surface of a body of stone, concrete, brick or mortar.

In this example, the drill 102 comprises a motor 104 and a drill bit 106 coupled to the motor 104. The drill 102 is a rotary percussion drill (i.e., a rotary hammer drill) for drilling into stone, concrete, brick or mortar. The drill 102 has a weight of less than or equal to 50 kg. More preferably, the drill 102 has a weight of between 5 kg and 40 kg.

More preferably, the drill 102 has a weight of between 5 kg and 30 kg. More preferably, the drill 102 has a weight of between 5 kg and 20 kg. More preferably, the drill 102 has a weight of between 5 kg and 15 kg. More preferably, the drill 102 has a weight of between 5 kg and 10 kg, e.g. 5 kg or 6 kg or 7 kg or 8 kg or 9 kg or 10 kg.

The drill bit 106 may be a masonry bit. The drill bit 106 may have a length of less than or equal to 1.5 m, e.g. less than or equal to 1 m. The drill bit 106 may have a length of less than or equal to 7 cm, e.g. between 4 cm and 6 cm, e.g. about 5 cm.

In this embodiment, the drill holder 100 comprises a base 108, a support member 110, and an arm 112.

In this embodiment, the base 108 comprises a substantially rectangular frame which may be constructed from, for example, welded box section steel. The base 108 further comprises a drill bit guide 114 for receiving the drill bit 106 of the drill 102 and guiding movement of the drill bit 106 in operation. The base 108 further comprises a plurality of through holes 116 for receiving bolts for fixing the base 108 to the surface 103.

In this embodiment, the support member 110 is an elongate member. The support member 110 may be a box section steel member that is welded to the base 108. In this embodiment, the support member 110 extends vertically upwards from the base 108. The support member 110 may have a length of, for example, less than or equal to 2 m, e.g. between 1 m and 2 m, or less than or equal to 1 m. The support member 110 comprises a plurality of through holes 118 spaced apart along its length.

In this embodiment, the arm 112 comprises a sliding member 120, a handle 122, a weight 124, and a clamp 126.

The sliding member 120 may be a metal (e.g. steel) member. The sliding member 120 is slidably mounted to the support member 110 such that the sliding member 120 is free to slide along the length of the support member 110. More specifically, in this embodiment, the sliding member 120 comprises a sleeve through which the support member 110 is positioned and is free to move. The sliding member 120 comprises at least one through hole 128.

The handle 122 is fixedly attached (e.g. welded) to the sliding member 120, and extends from the sliding member 120 in a first direction away from the drill bit guide 114 of the base 108.

The weight 124 and the clamp 126 are fixedly attached to the sliding member 120, and extend from the sliding member 120 in a second direction opposite to the first direction, i.e., in a direction towards the drill bit guide 114 of the base 108. The weight 124 is disposed between the sliding member 120 and the clamp 126. The clamp is located at a distal end of the arm 112.

The weight 124 may be an object constructed from a metal e.g. steel. The weight 124 may be a monolithic object. The weight 124 may be welded to the sliding member 120. The weight 124 may have a weight of between 0.5 kg and 10.0 kg. More preferably, the weight 124 may have a weight of between 0.5 kg and 5.0 kg. More preferably, the weight 124 may have a weight of between 0.5 kg and 4.5 kg. More preferably, the weight 124 may have a weight of between 0.5 kg and 4.0 kg. More preferably, the weight 124 may have a weight of between 0.5 kg and 3.5 kg. More preferably, the weight 124 may have a weight of between 0.5 kg and 3.0 kg. More preferably, the weight 124 may have a weight of between 0.5 kg and 2.5 kg. More preferably, the weight 124 may have a weight of between 1.0 kg and 2.5 kg. More preferably, the weight 124 may have a weight of between 1.0 kg and 2.0 kg. More preferably, the weight 124 may have a weight of between 1.0 kg and 1.5 kg.

The clamp 126 comprises at least one pair of opposing clamp jaws. The clamp 126 is configured to grip or hold the drill 102 thereby to prevent or oppose movement of the drill 102 relative to the arm 112. In particular, in this embodiment, the clamp 126 clamps the motor 104 of the drill 102, thereby to securely retain the drill 102. The clamp 126 holds the drill 102 in such a way that the drill bit 106 extends downwards from the motor 104 and is located through the drill bit guide 114 and onto or against the surface 103.

In this embodiment, the drill 102 is configured to be controlled by a controller 130 remote from the drill holder 100 and the drill 102. The controller 130 may activate (i.e., turn “on”) or deactivate (i.e., turn “off”) the drill 102. The controller 130 is coupled to the drill 102 via a wire 132. Preferably the wire 132 is housed within one or more of the base 108, the support member 110, and the arm 112, thereby to prevent impedance of the drilling operation by the wire 132 and to improve safety within the operational environment.

Thus, an embodiment of the drill holder 100 is provided.

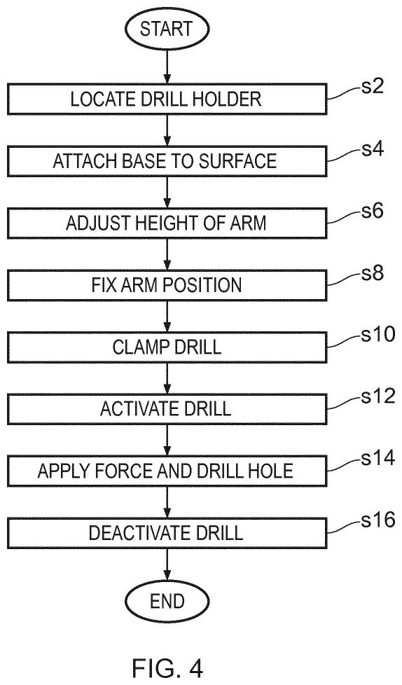

FIG. 4 is a process flow chart showing certain steps of an embodiment of a process of perform a drilling operation using the drill holder 100.

At step s2, the drill holder 100 is placed onto the surface 103 such that the base 108 is in contact with the surface 103 and the support member 110 extends vertically upwards from the base 108. The surface 103 is a surface of a body of material comprising stone, concrete, brick or mortar.

At step s4, the base 108 is fixedly attached to the surface 103 by fixing a plurality of bolts through the holes 116 and into the surface 103.

At step s6, a height of the arm 112 is adjusted by sliding the arm 112 along the support member 110. In this embodiment, a user holds the handle 122 and slides the arm 112 up/down along the support member 110 to a desired position along the support member 110. This desired position of the arm 112 along the support member 110 may be dependent on the side of the drill 102 that is to be held by the drill holder 100.

At step s8, the position of the arm 112 with respect to the support member 110 is fixed by positioning a locking pin (not shown in the Figures) through the hole 128 and into a hole 118 aligned therewith.

At step s10, the drill 102 is fixed into the clamp 126. In other words, the clamp 126 clamps the drill 102 thereby to prevent or oppose relative movement of the arm 112 and the drill 102. The drill 102 may be held such that the drill bit 106 is positioned through the drill bit guide 114 and such that a tip of the drill bit 106 contacts with the surface 103.

At step s12, the controller 130 activates (i.e., turns on) the drill 102 thereby to cause the drill bit 106 to rotate and move up and down rapidly.

At step s14, the locking pin is removed from the holes 128, 118. In other words, the arm 112 is released and is free to move along the length of the support member 110.

At step s16, the drill 102 is forced downwards by gravity. In particular, gravity acting on the drill 102 and on the arm 112 holding the drill 102 pulls the drill 102 (and the arm 112) against the surface 103. This downwards force applied to the drill 102 is due at least in part (and in some embodiments, primarily) to the weight of the weight 124.

Preferably, the weight of the weight 124 is selected such that a predetermined desired downwards force is applied to the drill 102. An appropriate weight of the weight 124 may be determined based on one or more parameters selected from the group of parameters consisting of: one or more properties of the drill 102 such as a weight of the drill 102, a power of the drill 102, a torque produced by the drill 102, a length of the drill bit 106, a diameter of the drill bit 106, a rotational speed of the drill bit 106, one or more physical properties of the material being drilled into, and/or one or more physical properties of the hole to be drilled, e.g. a depth of the hole.

The downwards force applied to the drill 102 moves the drill bit 106 downwards and into the surface 103, as indicated in FIGS. 1 and 2 by an arrow and the reference numeral 134. Thus, a hole is drilled into the surface 103.

At step s18, responsive to a hole of a desired depth being drilled into the surface 103, the controller 130 deactivates (i.e., turns off) the drill 102.

Thus, a process of performing a drilling operation using the drill holder 100 is provided.

The above described apparatus may be used to convert hand-held drills into “hands-free” drills. A drill held by the above described drill holder may be used to drill a hole into a surface without a human operator holding onto that drill. Thus, the exposure of human operators to hand-arm vibration tends to be reduced or eliminated, and safety of operators tends to be improved. For example, the likelihood of user developing, for example, hand-arm vibration syndrome or carpal tunnel syndrome as a result of drilling tends to be reduced.

Advantageously, the above described drilling operation tends to be faster and more accurate than those in which drills are held onto by human operators.

Advantageously, using the above described drill holder, the drill can be operated for a longer period of time than would conventionally be permitted were a human operator to be holding the drill.

Advantageously, the above described drill holder may hold a variety of different size and types of drill.

In the above embodiments, the drill holder is configured to hold a single drill. However, in other embodiments the drill holder is configured to hold multiple drills. For example, the drill holder may comprise multiple support members extending from a common base, each support member having a respective arm slidably mounted thereto for receiving a respective drill. This advantageously tends to allow for multiple holes to be drilled simultaneously. Also, this advantageously tends to allow for multiple drills to be operated in closer proximity to each other than would conventionally be permitted were human operators holding the multiple drills.

In the above embodiments, the base is configured to be fixed to the surface by bolting the base onto the surface. However, in other embodiments, movement of the base relative to the surface is prevented or opposed in a different way. For example, in some embodiments, friction between the base and surface is sufficient to prevent or oppose relative movement of the base and surface. In some embodiments, the base comprises a plurality of wheels (e.g. casters) on the underside of the base. These wheels may allow the drill holder to be easily moved into position, and may be lockable to prevent movement of the drill holder relative to the surface.

In the above embodiments, the weight is a monolithic object. However, in other embodiment, the weight may have a variable mass. For example, in some embodiments, the weight may comprise a container into which material may be added, and from which material may be removed. This advantageously allows for the adjustment or tuning of the downwards force that is applied to the drill. Thus, different downwards forces may be used for different applications. If the downwards force applied to the drill is too small, the drilling process may not be efficient, whereas if the downwards force applied to the drill is too large damage to the drill may occur. The ability to tune or vary the weight of the weight tends to mitigate such problems.

In the above embodiments, the drill is a rotary percussion drill (for drilling into stone, concrete, brick or mortar. However, in other embodiments, the drill is a different type of drill. Examples of appropriate drills include, but are not limited to, rotary percussion drills, hammer drills, rotary hammer drills, percussive breakers, pneumatic drills, and hydraulic drills.

In the above embodiments, the drill holder comprises a drill bit guide. However, in other embodiments, the drill bit guide is omitted.

In the above embodiments, the arm comprises a handle. However, in other embodiments, the handle is omitted.

In the above embodiments, the arm comprises a clamp for clamping the drill. However, in other embodiments, the arm comprises a different type of holding means (i.e., other than a clamp) for holding a drill.

In some embodiments, the drill holder comprises means for damping vibration caused by the drill drilling into the surface. For example, vibration damping means could be included in the arm, thereby to prevent or oppose vibration of the support member and base. Appropriate vibration damping means may include passive vibration isolation systems (such as resilient springs) or active vibration isolation systems.

In some embodiments, the drill holder comprises a cage or housing that surrounds, at least to some extent, the drill holder and the drill. This may improve operator safety.

In some embodiments, the drill holder comprises a vacuum system for extracting swarf (e.g. dust) from the drill location.

1. A drill holder comprising:
a base;
an elongate support member extending substantially perpendicularly from the base; and
an arm mounted to the support member; wherein
the arm extends substantially perpendicularly from the support member;
the arm is free to slide along at least a portion of the support member; and
the arm comprises:
holding means for holding a drill; and
a weight.

2. The drill holder of claim 1, wherein:
the arm comprises a first end and a second end opposite to the first end;
the arm is slidably attached to the support member at the first end;
the holding means are located at the second end; and
the weight is located between the first end and the second end.

3. The drill holder of claim 1, wherein:
the support member comprises a plurality of first through holes spaced apart along its length;
the arm comprises a second through hole configured to align with each of the first through holes when the arm is located at a different respective position along the length of the support member; and
the drill holder further comprises a locking pin for inserting through the second through hole and a first through hole aligned therewith.

4. The drill holder of claim 1, wherein the arm further comprises a handle.

5. (canceled)

6. (canceled)

7. (canceled)

8. (canceled)

9. (canceled)

10. The drill holder of claim 1, wherein the weight has a variable weight.

11. The drill holder of claim 1, further comprising a vacuum system coupled to the base.

12. The drill holder of claim 1, further comprising attachment means for fixedly attaching the base to a surface to be drilled.

13. The drill holder of claim 1, wherein the base comprises a plurality of lockable wheels.

14. The drill holder of claim 1, wherein the base comprises a guide hole for receiving and guiding a drill bit of a drill held by the holding means.

15. The drill holder of claim 1, wherein the arm further comprises vibration damping means.

16. A system comprising
a plurality of drill holders, each of the drill holders being in accordance with claim 1; wherein
the bases of the drill holders are integrally formed.

17. A drilling system comprising:
a drill holder in accordance with claim 1; and
a drill fixedly held by the holding means of the drill holder.

18. The drilling system of claim 17, wherein the drill is selected from a group of drills consisting of a rotary percussion drill, a hammer drill, a rotary hammer drill, a percussive breaker, an electric drill, a pneumatic drill, and a hydraulic drill.

19. The drilling system of claim 17, further comprising a controller for activating and deactivating the drill, wherein the controller is remote from the drill holder and the drill.

20. The drilling system of claim 17, wherein a weight of the drill is less than or equal to 50 kg.

21. The drilling system of claim 17, wherein a weight of the drill is between 5 kg and 10 kg.

22. A drilling method comprising:
fixedly coupling the base of a drill holder to a surface of material to be drilled, wherein the drill holder comprises the drill holder of claim 1;
holding, by the holding means, a drill;
activating the drill; and
applying, by the weight, a downwards force to the drill, thereby to force the drill against the surface.

23. The drilling method of claim 22, wherein:
prior to the holding of the drill by the holding means, the arm is prevented from moving with respect to the support member by means of a locking pin positioned through a first hole through the arm and a second hole through the support member, the first and second holes being aligned; and
the method further comprises, following activation of the drill, removing the locking pin from the first and second holes.

24. The drilling method of claim 22, wherein activating the drill comprises remotely activating the drill by a controller remote from the drill holder and the drill.

25. The drilling method of claim 22, wherein the material comprises at least one of stone, concrete, brick, or mortar.
